(19) United States
(12) Patent Application Publication
(10) Pub. No.: US 2026/0181737 A1
(43) Pub. Date: Jun. 25, 2026

(54) METHODS AND MECHANISM TO ENABLE MULTI-LINK MILLIMETER WAVE REQUEST AND REPORT

(71) Applicant: INTERDIGITAL PATENT HOLDINGS, INC., Wilmington, DE (US)

(72) Inventors: Zinan LIN, Basking Ridge, NJ (US); Hanqing Lou, Syosset, NJ (US); Xiaofei Wang, North Caldwell, NJ (US); Mahmoud Saad, Montreal (CA); Rui Yang, Melville, NY (US)

(73) Assignee: INTERDIGITAL PATENT HOLDINGS, INC., Wilmington, DE (US)

(21) Appl. No.: 19/128,829

(22) PCT Filed: Nov. 9, 2023
(86) PCT No.: PCT/US2023/079219

§ 371 Date: May 9, 2025

Related U.S. Application Data
(60) Provisional application No. 63/424,010, filed on Nov. 9, 2022.

(51) Int. Cl. H04W 88/06; H04W 84/12; H04W 88/02

(52) U.S. Cl. CPC H04W 88/06; H04W 84/12; H04W 88/02

(57) ABSTRACT

Method and devices for cross-link signaling are described in which a multi-link device (MLD) communicates to another device using a first wireless link and a secondary wireless link. Control and response information for establishing/maintaining the secondary wireless link may be communicated in signaling fields of a frame over the first wireless link to enable a more reliable control information exchange than may otherwise be available via the secondary wireless link. In some embodiments, the first wireless link is a sub-7 GHz link and the secondary wireless link is a mmWave link. Signaling used for configuring parameters of the first wireless link, e.g., control field, A-Control subfield of HT Control field, Control Frame, BQR control subfield, HLA control subfield, TRS control field, etc., may be enhanced to provide related signaling for another separate link (secondary link) between devices that do not carry the signaling information.

### CROSS-REFERENCE TO RELATED APPLICATIONS

This application claims the benefit of U.S. Provisional Application No. 63/424,010, filed Nov. 9, 2022, the contents of which are incorporated herein by reference.

### BACKGROUND

A wireless local area network (WLAN) in Infrastructure Basic Service Set (BSS) mode may have an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Recent efforts have been directed to improved reliability of WLAN connectivity, reduce latencies, increase manageability, and increase throughput consumption. Millimeter wave (mmW or mmWave) operation has been proposed as a potential feature to help achieve one or more of these goals, especially considering recently defined multi-link operation (MLO) in standardization efforts for WLANs.

The mmWave operation may help achieve objectives mentioned above. From one perspective, all devices operating in mmWave band/link should be MLO-capable and should have at least one active sub-7 GHz link. The discovery and association procedure for this may be done in a lower band/link, where scheduling and broadcast may be provided at a lower band/link. Beamforming (BF) training with sector sweep (SS) may be performed in the mmW band/link, but BF training sequence can be triggered or scheduled from a lower band and feedback can be provided in a lower band. Various potential options need to be resolved for wide-spread adoption and successful communication.

### SUMMARY

Embodiments disclosed herein may relate to addressing objectives mentioned previously, by providing an enhanced MAC header which can carry the request and response information for mmW link via a Frame Control field which is carried in the control/management frame transmitted in a sub-7 GHz band. To leverage Multi-Link Operation, embodiments relating to a cross-link signaling mechanism, to enable the frame transmitted on one link, to carry request/response information for another link different from the link used for transmission of this frame. In certain embodiments, this cross-link signaling can be achieved by enhancing the existing Frame Control field design. Certain aspects relate to signaling in a first wireless link an enhanced control frame or an enhanced data/management frame, capabilities and link establishment information for a second wireless link, different than the first wireless link. Additionally, or alternatively, other embodiments relate to cross-link signaling by enhancing the existing A-Control field design in an MLO system.

According to one aspect, methods and devices are disclosed for a multi-link (ML) station (STA) including transmitting a frame of the ML STA to a ML device on a first wireless link, the frame including a high throughput control (+HTC) field indicating the frame contains control information for a second wireless link with the ML device and where the second wireless link is different than the first wireless link.

In one aspect, the control information includes request or response information to establish or maintain the second wireless link. In some embodiments, the first wireless link comprises a sub-7 GHz link and the second wireless link comprises a mmWave link. In other embodiments the first wireless link comprises a 3GPP link and the second wireless link comprises an 802.11 link, or vice versa. In some embodiments, the control information comprises an A-Control subfield of a high efficiency (HE) variant high throughput (HT) control field.

The ML STA may receive a frame of the ML device over the first wireless link, the received frame including a high throughput (+HTC) field indicating the received frame contains second control information for the second wireless link. In one embodiment, the second control information includes request or response information to establish or maintain the second wireless link. In one embodiment, the second wireless link is established or operated using the second control information received over the first wireless link.

In some aspects, the control information may be included in a HE HT control field with an enhanced A-Control subfield. According another aspect, the control information is present in an enhanced bandwidth query report (BQR) subfield. In another aspect, the control information is present in an enhanced high efficiency link adaptation (HLA) control subfield. In another aspect, the control information is present in an enhanced triggered response scheduling (TRS) control field. In yet another aspect, the control information may include an enhanced transmission opportunity (TXOP) sharing resource request. Various alternatives and additional features are also disclosed herein.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example medium access control (MAC) header according to various embodiments;

FIG. 3 illustrates an example A-Control subfield of a high efficiency (HE) variant of high throughput (HT) Control Field format;

FIG. 4 illustrates an example Control subfield format according to certain embodiments;

FIG. 5 shows an of example HE MAC Capabilities Information Field format according to some embodiments;

FIG. 6 is a representation of an example Control Frame with Enhanced Frame Control Field Format utilized in certain embodiments;

FIG. 7 illustrates an example sequence diagram of operation using an Enhanced Control Frame of some embodiments;

FIG. 8 is a flow diagram detailing a method of communicating in a wireless network according to one embodiment;

FIG. 9 shows a representative example of a high efficiency (HE) high throughput (HT) Control Field with an Enhanced A-Control subfield according to one embodiment;

FIG. 10 shows an example Control Information subfield of an Enhanced Bandwidth Query Report (BQR) Control subfield of various embodiments;

FIG. 11 illustrates a sequence diagram of example operation using an Enhanced BQR Poll (BQRP) trigger frame of various embodiments;

FIG. 12 illustrates an example Control Information subfield format using an Enhanced high efficiency (HE) link adaptation (HLA) Control subfield in one embodiment;

FIG. 13 shows another option for a Control Information subfield in an Enhanced HLA Control subfield in various embodiments;

FIG. 14 is an example sequence diagram illustrating a method of communicating in a wireless network using unsolicited modulation and coding scheme (MCS) feedback (MFB) with Enhanced HLA Control according to one embodiment;

FIG. 15 shows a sequence diagram illustrating a method of communicating in a wireless network using solicited MFB with Enhanced HLA Control according to an embodiment;

FIG. 16 illustrates an exemplary Control Information subfield format in embodiments using an Enhanced triggered response scheduling (TRS) Control Field;

FIG. 17 illustrates an example Control Field in embodiments when a Control ID is set for Enhanced transmission opportunity (TXOP) sharing resource request;

FIG. 18 shows an example Control Information subfield format in an Enhanced TXOP sharing resource request subfield as one option of various embodiments;

FIG. 19 shows an example Control Information subfield format in an Enhanced TXOP sharing resource request subfield as a second option of various embodiments

FIG. 20 is a diagram illustrating a method of communicating in a wireless network utilizing an unsolicited TXOP sharing resource request according to exemplary embodiments;

FIG. 21 is a diagram illustrating a method of communicating in a wireless network utilizing a solicited TXOP sharing resource request according to exemplary embodiments.

### DETAILED DESCRIPTION

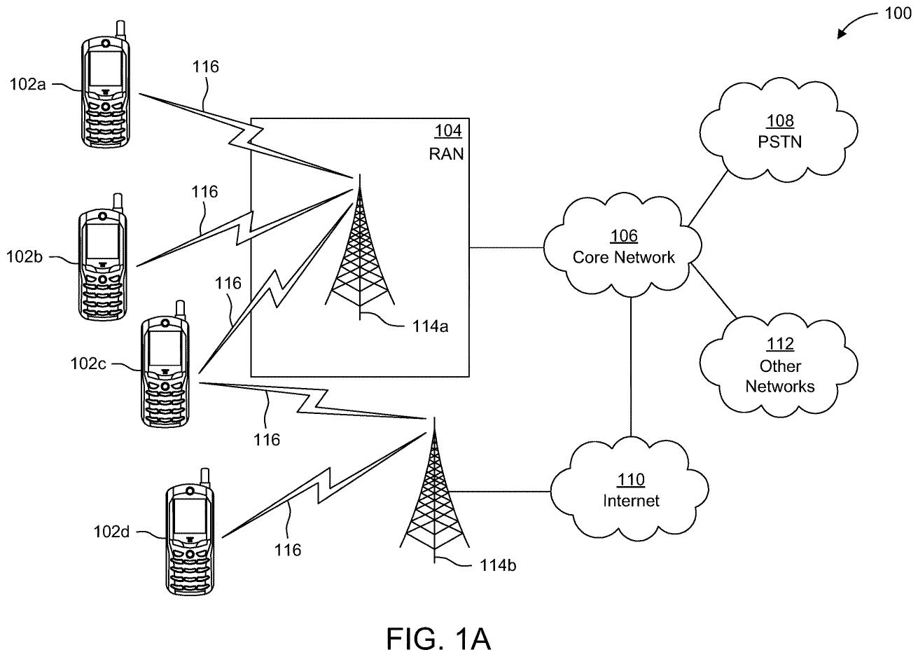

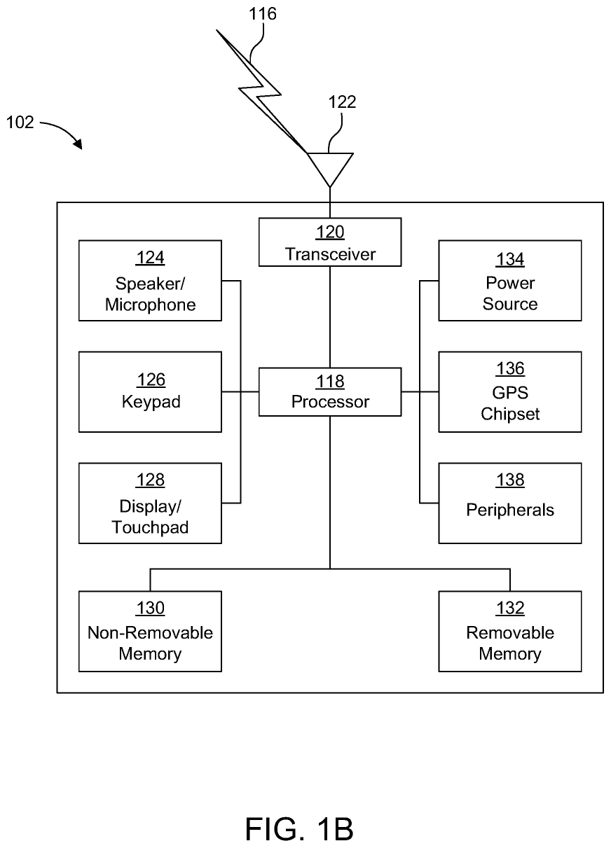

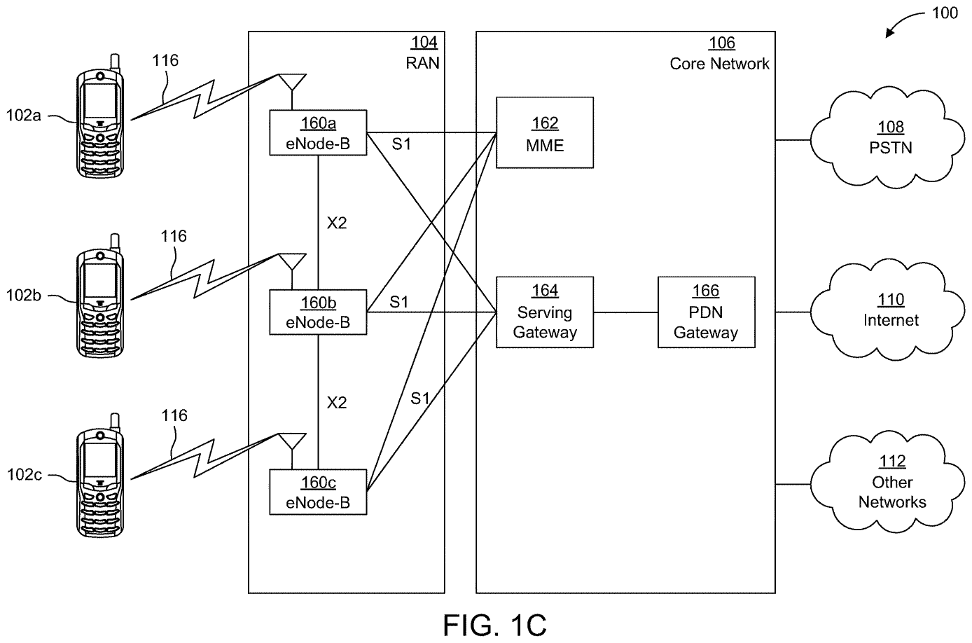

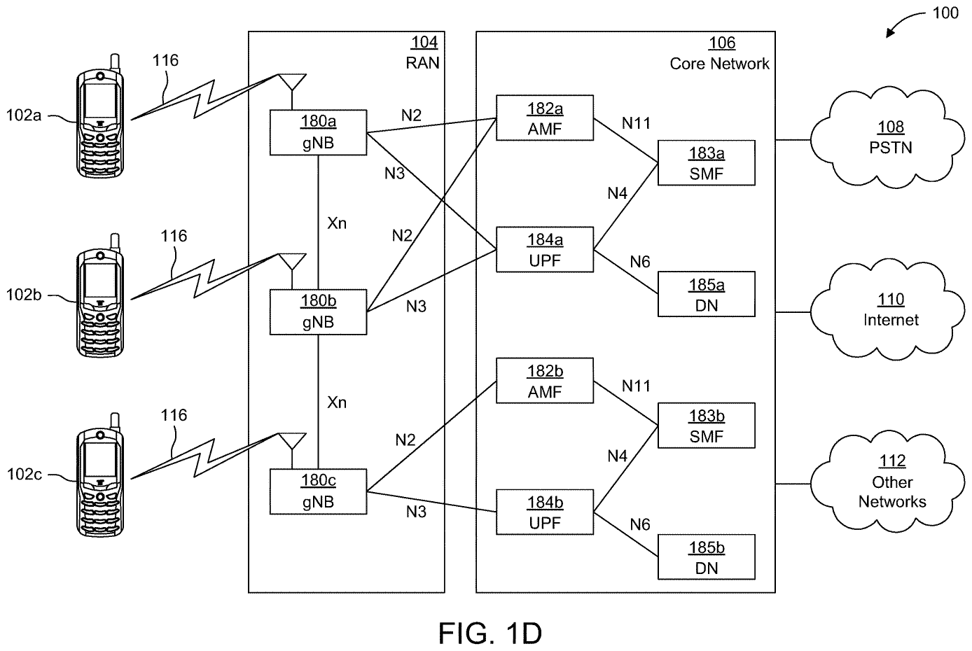

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) PacketAccess (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Various embodiments will now be described in reference to examples pertaining to 802.11 networking and its related standards for understanding. It should be noted that the discussion of specific standards does not limit the embodiments in any manner but are used merely for example reference.

To improve spectral efficiency 802.11ac introduced the concept for downlink Multi-User MIMO (MU-MIMO) transmission to multiple STA's in the same symbol's time frame, e.g. during a downlink OFDM symbol. The potential for the use of downlink MU-MIMO is also currently considered for 802.11ah. It is important to note that since downlink MU-MIMO, as it is used in 802.11ac, uses the same symbol timing to multiple STA's interference of the waveform transmissions to multiple STA's is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

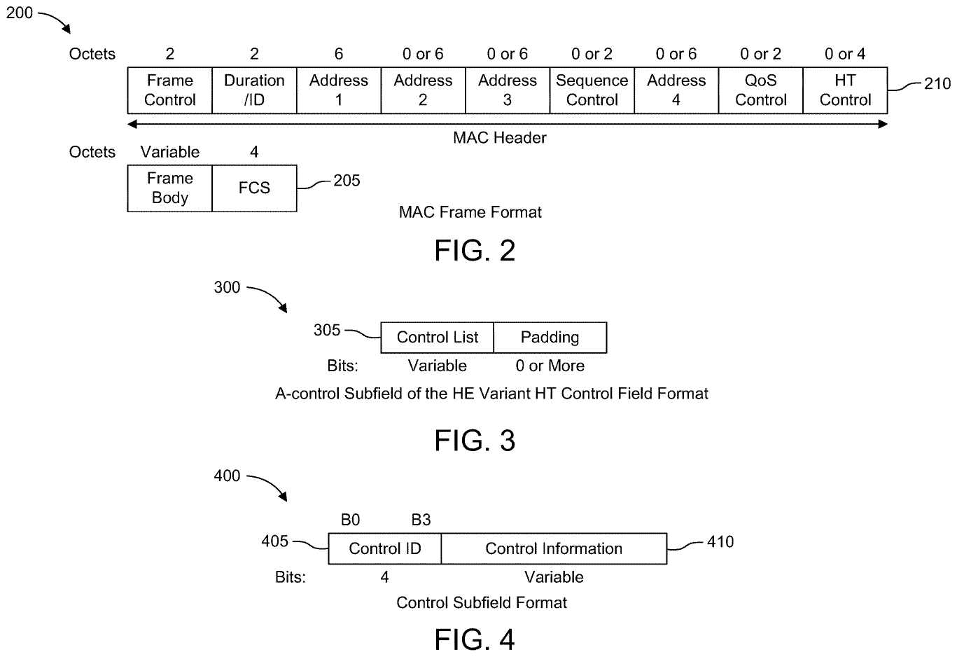

Referring to FIG. 2, an example medium access control (MAC) frame format 200 will be discussed. A STA shall be able to properly construct a subset of the frames specified for transmission and to decode a (potentially different) subset of the frames, upon validation following reception. The particular subset of these frames that a STA constructs and decodes is determined by the functions supported by that particular STA. A STA may validate every received frame using the frame check sequence (FCS) 205 and to interpret certain fields from the MAC headers of all frames. A STA may transmit frames using the frame formats defined in various 802.11 standards. The MAC frame format includes a set of fields that occur in a fixed order in all frames. FIG. 2 depicts the general MAC frame format 200 for a protocol version 0 (PVO) MAC protocol data unit (MPDU).

The high throughput (HT) Control field 210 may be present in a Control Wrapper frame and is present in QoS Data, (802.11ax) QoS Null, and Management frames as determined by the +HTC subfield of the Frame Control field. The HT Control field 210 transmitted by a by a non-China Millimeter-Wave Multi-Gigabit (non-CMMG) STA may have three variants: the HT variant, and the very high throughput (VHT) variant, and the high efficiency (HE) variant. The variant formats are differentiated by the values of B0 and B1 as defined in Table 1 below:

TABLE 1
HT CONTROL FIELD FORMAT

| Variant | B0 | B1 | B2-B29 | B30 | B31 |
|---|---|---|---|---|---|
| HT | 0 | HT Control Middle | | AC Constraint | RDG/More |
| | | | | | PPDU |
| VHT | 1 | 0 | VHT Control Middle | AC Constraint | RDG/More |
| | | | | | PPDU |

| | | | |
|---|---|---|---|
| HE | 1 | 1 | A-Control |

FIG. 3 shows the format 300 of the A-Control (Aggregated Control) subfield of the HE variant HT Control field. The A-Control subfield is 30 bits in length. The Control List subfield 305 contains one or more Control subfields. FIG. 4 shows the format 400 of each Control subfield.

The Control ID subfield 405 indicates the type of information carried in the Control Information subfield 410. The length of the Control Information subfield 410 is fixed foreach value of the Control ID subfield 405 that is not reserved. The values of the Control ID subfield 405 and the associated length of the Control Information subfield 410 are defined in Table 2 below:

TABLE 2
Control ID Subfield Values

| | | Length of | |
|---|---|---|---|
| | | the Control | Content of the |
| Control | | Information | control |
| ID | | subfield | Information |
| Value | Meaning | (bits) | subfield |
| 0 | Triggered response | 26 | TRS Control |
| | scheduling (TRS) | | |
| 1 | Operating mod (OM) | 12 | OM Control |
| 2 | HE link adaptation (HLA) | 26 | HLA Control |
| 3 | Buffer status report (BSR) | 26 | BSR Control |
| 4 | UL power headroom (UPH) | 8 | UPH Control |
| 5 | Bandwidth query report (BQR) | 10 | BQR Control |
| 6 | Command and status (CA) | 8 | CAS Control |
| 7 | EH operating mode (EHT OM) | 6 | EHT OM |
| | | | Control |
| 8 | Single response scheduling | 10 | SRS Control |
| | (SRS) | | |
| 9 | AP assistance request (AAR) | 20 | AAR Control |
| 10-14 | Reserved | | |
| 15 | One need expansion surely | 26 | Set to all 1s |
| | (ONES) | | |

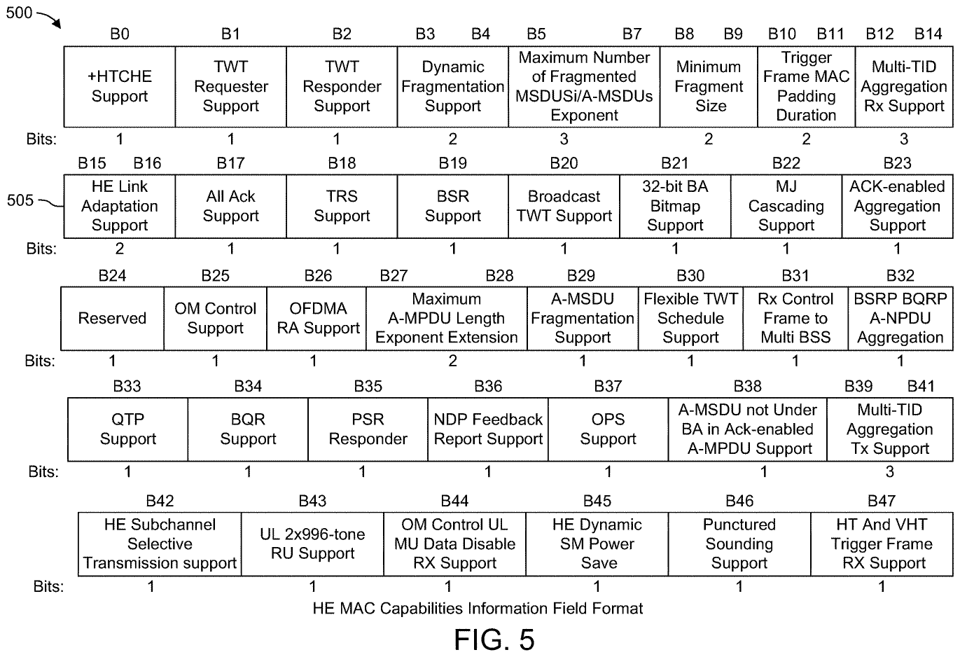

Referring to FIG. 5, a format of the HE MAC Capabilities Information field 500 is shown. A HE STA declares that it is an HE STA by transmitting a HE Capabilities element. The HE capabilities element contains Element ID, length, Element ID Extension, HE MAC Capabilities Information, HE PHY Capabilities Information, Supported HE-MCS And NSS Set and PPE Thresholds (optional) subfields.

The HE Link Adaptation Support subfield 505 of the HE MAC Capabilities Information field 500 is given in Table 3 below:

TABLE 3
HE Link Adaptation Support Subfield in HE MAC Capabilities Information field

| Subfield | Definition | Encoding |
|---|---|---|
| HE Link Adaptation | Indicates support for link adaptation | If the +HTC-HE Support subfield is |
| Support (B15-B16) | using the HLA Control subfield. | 1: |
| | | Set to 0 (No Feedback) if the STA |
| | | does not provide HE MFB. |
| | | Set to 2 (Unsolicited) if the STA |
| | | can receive and provide only |
| | | unsolicited HE MFB. |
| | | Set to 3 (Solicited and unsolicited) |
| | | if the STA is capable of receiving |
| | | and providing HE MFB in |
| | | response to HE MRQ and if the |
| | | STA can receive |
| | | and provide unsolicited HE MFB. |
| | | The value 1 is reserved. |
| | | HE MFB and HE MRQ are MFB |
| | | and MRQ using HLA Control |
| | | subfield, respectively. |
| | | Reserved if the +HTC-HE Support |
| | | subfield is 0. |

Link adaptation using the HE link adaptation (HLA) Control subfield was previously defined in 802.11ax. The appearance of more than one instance of an HLA Control subfield with the modulation and coding scheme (MCS) request (MRQ) field equal to 1 within a single PPDU shall be interpreted by the receiver as a single request for link adaptation feedback.

The MCS feedback (MFB) requester may specify the resource unit (RU) index and bandwidth (BW) requesting the link adaptation feedback. On receipt of an HLA Control subfield with the MRQ subfield equal to 1, an MFB responder computes the HE-MCS, NSS, and DCM of the RU and BW specified in the MRQ and these estimates are based on the same RU of the PPDU carrying the MRQ. The PPDU carrying MRQ may include the RU requested for MFB. The MFB responder labels the result of this computation with the MRQ sequence identifier (MSI) value from the HLA Control subfield in the received frame carrying the MRQ. The MFB responder may include the received MSI value in the MSI field of the corresponding response frame. In the case of a delayed response, this allows the MFB requester to associate the MFB with the soliciting MRQ.

Unsolicited HE-MCS, NSS, DCM, BW, and RU estimates reported in an HLA Control subfield sent by a STA may be computed based on the most recent PPDU received by the STA that matches the description indicated by the PPDU format, Tx Beamforming, and Coding Type subfields in the same HLA Control subfield.

Multi-Link Operation (MLO) was introduced in 802.11be, and enables a non-AP multi-link device (MLD) to discover, authenticate, associate, and set up multiple links with an AP MLD. An AP (referred to as a reporting AP) affiliated with an AP MLD may advertise operating capabilities and operating parameters of another AP (referred to as a reported AP) affiliated with the same AP MLD by including a Multi-Link Element. Each link enables channel access and frame exchanges between the non-AP MLD and the AP MLD based on the supported capabilities exchanged during association.

An initial problem may exist in request and/or response through the Frame Control field in an MLO system. In 802.11 mmW operation, robust communication, suitable for control information exchange, via a mmW link may require a strong directionality between transmitter and receiver and this communication establishment may take longer time than lower band communication, e.g., sub-7 GHz. Furthermore, communication quality may be easily impacted in mmW bands by multiple factors, e.g., the movements of the surrounding objects, which may cause the transmission of control/management frames to be susceptible. Therefore, there may be a preference for an enhanced MAC header which can carry the request and response information for a mmW link via a Frame Control field which is carried in the control/management frame transmitted in a sub-7 GHz band. In general, to leverage the Multi-Link Operation, it would be beneficial to introduce a cross-link signaling mechanism, which enables the frame transmitted on one link to carry the request/response information for another link which is different from the link used for transmission of this frame. In certain embodiments, this cross-link signaling can be achieved by enhancing the existing Frame Control field design.

An additional issue may relate to request and/or response through an aggregated control (A-Control) field in the presently defined MLO system. In the current A-Control field (e.g. FIG. 3, 300), the contents of the Control Information subfield (e.g., FIG. 4, 410) refer to the information of the link where the frame carries the Control Information subfield. However, in mmW operation, the mmW link may be fragile. It can be easily impacted by the change of surrounding environments, e.g., the movement of the surrounding objects, and may require more frequent beam setup/re-setup in the mmW link. Therefore, it may be beneficial to enable some request and/response information related to the mmW link to be transmitted on the more stable link, e.g., sub-7 GHz link. Accordingly, embodiments disclosed herein may use an enhanced A-Control field such that the A-Control field which is carried by the frame transmitted on sub-7 GHz, may contain the request and/or response information for a mmW link. Certain embodiments disclosed herein thus relate to a cross-link signaling mechanism, which enables a frame transmitted on one link to carry request/response information for another link which is different from the link used for transmission of this frame. In one embodiment, this cross-link signaling can be achieved by enhancing the existing A-Control field design in an MLO system.

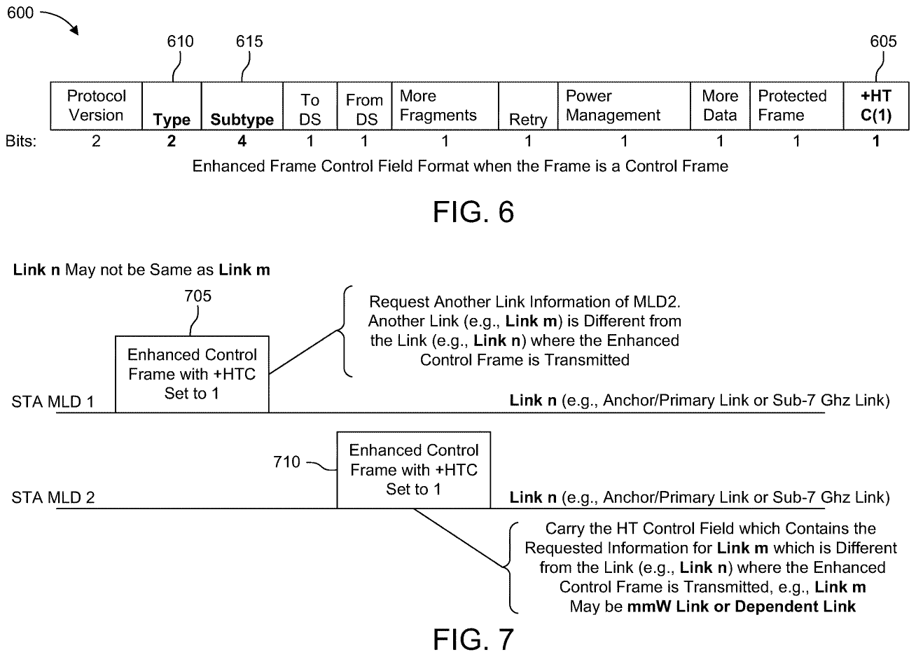

In one embodiment, referring to FIG. 6, an Enhanced Frame Control field 600 may be used to exchange the response or request information for another link, which is different from the link where the frame carrying the Frame Control field is transmitted. For example, in one embodiment, a STA supporting a mmW link may be able to support the multi-link operation (MLO). In this example, if a mmW link is enabled, then there will be an additional link, e.g., sub-7 GHz, that may be enabled as well. In this example, mmW link may be referred to as a “dependent” link and the enabled sub-7 GHz link is referred to as the “primary” or “anchor” link. It should be recognized that the multi-link operation of the embodiments described may be applied to any type of primary and/or secondary link where it may be beneficial to communicate control information over the primary link for operating a secondary link. Examples of different links may include 802.11, 3GPP, Bluetooth, UWB links or any other existing or future primary/secondary links where similar advantages may be obtained. Accordingly, the described embodiments are not limited to any particular primary or secondary link except as claimed herein.

Enhanced Control Frame: In one embodiment, a control frame can be used to indicate the frame contains an HT Control field and this HT Control field may contain the information of another link. In reference to FIG. 6, for example, if the Control frame 600 is transmitted in the sub-7 GHz band (e.g., 2.4 GHz, or 5 GHz, or 6 GHz) link, i.e., link 1 and the +HTC subfield 605 is set to 1, the information carried in the HT Control field may indicate request or response information of another link (e.g. mmW or dependent link), i.e., link 2. In other words, the +HTC subfield 605 may be set to 1 in a Control frame 600 transmitted in one link by a STA to another STA to indicate that the frame contains an HT Control field which carries the response or the request for another link. FIG. 6 depicts an exemplary Frame Control field format 600 when the Type subfield 610 is set to 1 (which represents a control frame) and the Subtype subfield 615 is set to 15 (or 0 or 1). Alternatively, it can be the combination of any value in the Subtype subfield 615 and the Type subfield 610 is set to 1. Table 4 below shows exemplary valid type and subtype combinations for an enhanced control frame signaling of FIG. 6 according to certain embodiments.

TABLE 4
Type and Subtype Combinations for an Enhanced Control Frame

| Type | | | |
|---|---|---|---|
| value | Type | Subtype value | |
| B3 B2 | description | B7 B6 B5 B4 | Subtype description |
| 01 | Control | 0000 or 0001 | HT Control for another link |
| | | or 1111 or any | (e.g., mmW link, or dependent |
| | | other value | link) which is different from |
| | | | the link where the enhanced |
| | | | control frame is transmitted. |
| | | | For example, if HTC = 1, the |
| | | | HT Control for another link is |
| | | | present |

FIG. 6 shows an exemplary Enhanced Frame Control field format 600 is present when the frame is a Control frame, e.g., the Type subfield is set to 1, and the Subtype subfield is set to 15 (or 0 or 1 or any other value). In the case that the Type subfield 610 is set to 1 (which represents the control frame), the Subtype subfield 615 is set to 15 (or 0 or 1 or any other value) and +HTC subfield 605 is set to 1, the enhanced control frame identifies that request or response information for another link (e.g., mmW or dependent link) is present. The signaling here is for a link different than the link where the enhanced control frame is transmitted. This is referred to in the embodiments as “cross-link signaling.”

For example, if it is an HE link adaptation (HLA) Control in the A-Control subfield, it represents the link adaptation information (e.g., solicited MCS/Nss or unsolicited MCS/Nss) for another link, e.g., mmW link or dependent link. If it is a bandwidth query report (BQR) control in the A-Control subfield, it contains the bandwidth query report based for bandwidth query report operation to assist UL MU transmission in another link, e.g., mmW link or dependent link.

In another example, if it is TRS Control in the A-Control subfield, it contains triggered response scheduling (TRS) information for soliciting an TB PPDU which may be transmitted in another link which is different from the link which carries the enhanced control frame. The information carried in the Control Information subfield in the TRS Control subfield may indicate the information for the link where the TB PPDU will be transmitted.

Embodiments for an Enhanced Data/Management Frame will now be described. In one embodiment, the enhanced HT Control field can be carried in the enhanced data/management frame. This enhanced HT Control field may indicate the responding/request information for the dependent link other than the link where the data/management frame is transmitted, e.g., mmW link or dependent link. Table 5 below depicts exemplary valid type and subtype combinations for an enhanced management/data frame according to some embodiments.

TABLE 5
Type and Subtype Combinations for
an Enhanced Management/Data Frame

| Type | Type | Subtype | |
|---|---|---|---|
| value | descript- | value B7 | |
| B3 B2 | ion | B6 B5 B4 | Subtype description |
| 00 | Manage- | 1111 | HT Control for another link (e.g., |
| | ment | | mmW link, or dependent link) which |
| | | | is different from the link where |
| | | | the enhanced Management frame is |
| | | | transmitted. |
| | | | For example, if HTC = 1, the HT |
| | | | Control for another link is present |
| 10 | Data | 0001 or 0010 | HT Control for another link (e.g., |
| | | or 0010 or | mmW link, or dependent link) which |
| | | 0101 or 0110 | is different from the link where |
| | | or 0111 or | the enhanced Data frame is |
| | | 1101 | transmitted. |
| | | | For example, if HTC = 1, the HT |
| | | | Control for another link is present |

In one embodiment, the capability of indicating the HT control information for another link (e.g., mmW link, dependent link) that is not the link where the frame is transmitted using the enhanced Frame Control field, may be included in a subfield of a MAC Capabilities Information field. If a STA indicates it supports the enhanced Frame Control field, e.g., this subfield in MAC Capabilities Information field is set to 1, the AP can request the non-AP STA to send the information of another link, or the STA can send the unsolicited information of another link which is carried in the enhanced Frame Control field to another STA. If the STA does not indicate it supports the enhanced Frame Control field, e g., this subfield in MAC Capabilities Information field is set to 0, then the AP cannot request the non-AP STA to send the enhanced Frame Control field, or the STA cannot send the unsolicited information carried in the enhanced Frame Control field to another STA.

Referring to FIG. 7, a method for communicating in a wireless network using an Enhanced Control frame for cross-link signaling is shown and described. In one embodiment, a STA multi-link device (MLD) may send a request to another STA MLD asking the information of Link m, e.g., a mmW link or dependent link, via an Enhanced Control frame. Link m may be different from the link (e.g., Link n) where the enhanced Control frame is transmitted. As shown in FIG. 7, the first station (STA MLD1) sends an enhanced control frame 705 with +HTC subfield set to 1 (as discussed previously). It may request cross-link information of a second station (STA MLD2), e.g., HLA, BQR, etc. Upon reception of the enhanced control frame 705 with +HTC=1 from MLD1, STA MLD2 may respond with the enhanced control frame 710 with +HTC set to 1. The enhanced control frame may carry the information requested by STA MLD1. The information may represent the cross-link, e.g., Link m, which is different from the link where the enhanced control frame is transmitted. In addition, STA MLD2 may also send unsolicited information of Link m, e.g., mmW link/dependent link, to STA MLD1 on Link n (e.g., anchor/primary link), which is different from Link m. In other words, STA MLD2 may directly send the enhanced Control frame 710 with +HTC set to 1 which carries Link m information on Link n, where Link m may not be same as Link n.

It should be noted that the method 700 described in reference to FIG. 7, using an enhanced control frame operation may, additionally or in the alternative, utilize the enhanced Data/Management frame previously described.

Other embodiments for utilizing an Enhanced A-control subfield for cross-link signaling will now be described. An enhanced A-control subfield may be used to obtain the response or request information for another link which is different from the link where the frame carrying this A-control subfield is transmitted in a similar fashion to the previous embodiments.

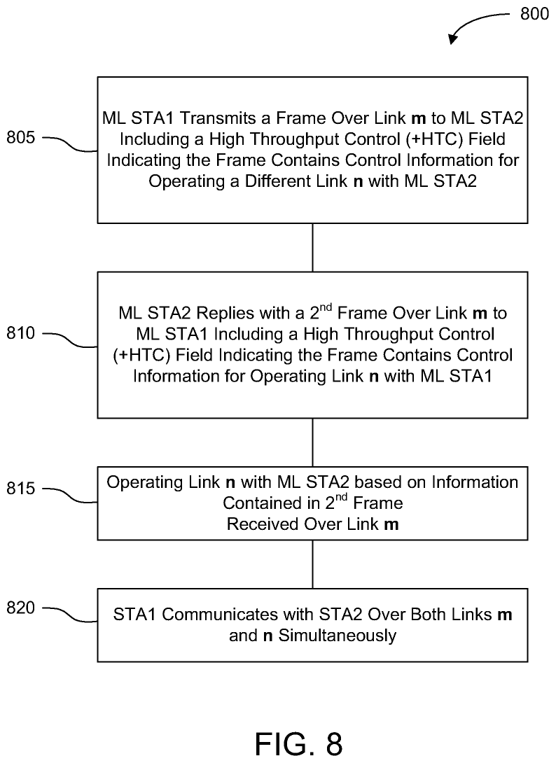

Turning to FIG. 8, a method 800 for a multi-link STA communicating in a wireless network with a multi-link device is shown. In method 800, a first wireless link m, e.g., a sub-7 GHz link, is used to communicate between ML STA1 and ML STA2. ML STA1 transmits 805 a frame over link m to ML STA2 where the frame includes a high throughput control (+HTC) field or an newly defined control field or other type of field indicating the frame contains control information for operating a different wireless link n, e.g., a mmWave link, with ML STA2. ML STA2 replies 810 with a second frame over link m to ML STA1 where the second frame includes a high throughput control (+HTC) field or an newly defined control field or other type of field indicating the second frame contains control information for operating link n with ML STA1. The operation 815 on the second wireless link n is based on the information contained in the frames exchanged between ML STA1 and ML STA2 over wireless link m and ML STA1 and ML STA2 may then communicate 820 to each other over both link m and n simultaneously. While not shown in FIG. 8, control information for maintaining second wireless link n may continuously be communicated over first wireless link m.

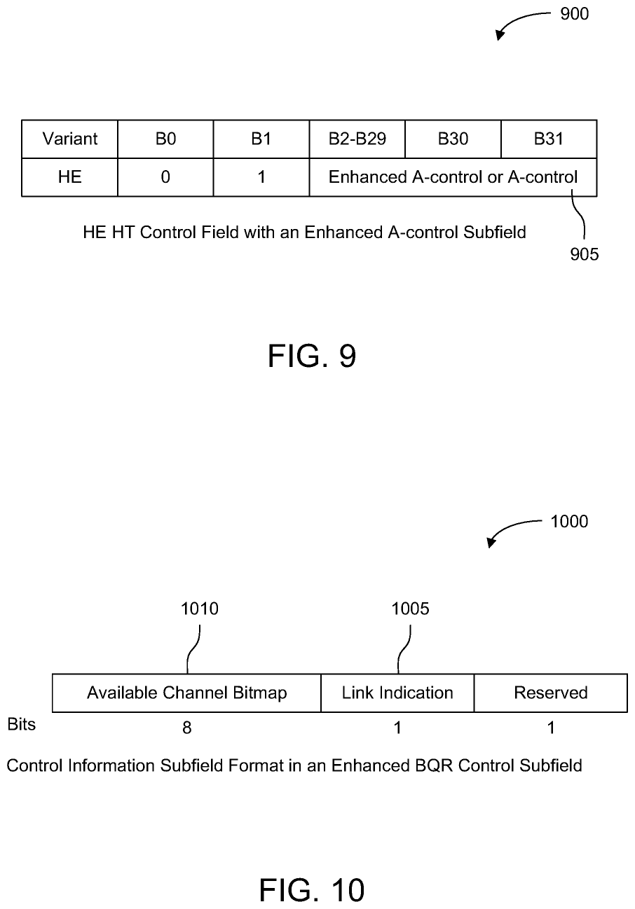

In one embodiment, referring to FIG. 9, the STA may utilize an enhanced A-control subfield. In the example of FIG. 9, an exemplary HE HT Control field 900 is shown to contain an Enhanced A-Control subfield 805 to signal request or response information of a secondary link, which is different from the primary link used for the transmission of the frame carrying the enhanced A-control subfield 905. It is worthy of noting, that depending on the STA capability or Control ID in the A-control field, the HE HT Control field may also be a legacy A-Control field. An HE HT Control field 900 that contains the enhanced A-Control subfield 905 may also be referred to herein as an “enhanced” HT Control field.

Embodiments for Enhanced BQR Control will now be described in reference to FIG. 10. The Enhanced BQR Control subfield 1000 may contain the bandwidth query report (BQR) used for bandwidth query report operation in the link used (i.e., primary link) for the transmission of the frame that carries BQR Control or another link (i.e., secondary link) which is different from the link used for transmission of this frame. In certain embodiments, the Link Indication subfield 1005 carries the information to indicate the available channel bit map represents the link where the frame that carries enhanced BQR Control information is transmitted, or another link which is not used for transmission of this frame. For example, if the Link Indication Subfield 1005 is set to 0, the Available Channel Bitmap subfield 1010 indicates the available channels of the STA in the link used for the transmission that carries enhanced BQR Control, e.g., lower band link (or sub-7 GHz link); if the Link Indication Subfield 1005 is set 1, the Available Channel Bitmap subfield 1010 indicates the available channels of the STA in the link which is not used for the transmission (secondary link) that contains enhanced BQR Control, e.g., the mmW link or dependent link. FIG. 9 depicts an exemplary Control Information subfield format in an enhanced BQR Control subfield 1000 according to one embodiment. Note that it may use more than 1-bit to indicate the specific link. In other words, Link Indication subfield 1005 may contain 1 or more than 1 bit. FIG. 10 depicts the exemplary Control Information subfield format in an enhanced BQR Control subfield 1000 of certain embodiments.

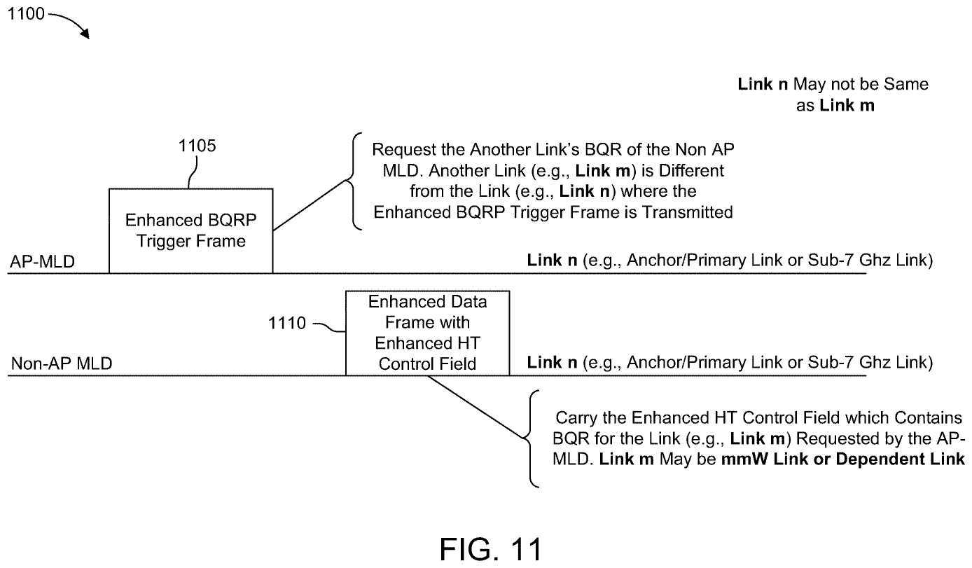

Referring to FIG. 11, a method 1100 of communication in a wireless network using an enhanced BQRP Trigger frame will be described. A non-AP MLD may send the enhanced BQRs to assist its AP MLD in allocation of DL MU and UL MU resources: (i) in the link where the frame carries BQR information; or (ii) another link which is different from the link where the frame carries BQR information. The non-AP MLD may either implicitly deliver BQRs in the enhanced BQR Control subfield of a frame transmitted to the AP MLD (unsolicited enhanced BQR) or explicitly deliver BQRs in a frame sent to the AP MLD in response to a BRQ Trigger frame (solicited enhanced BQR). The solicited or unsolicited enhanced BQRs can be carried in the enhanced data frame with an enhanced HT Control field (as previously discussed) or the enhanced control frame with an enhanced HT Control field (as indicated in FIG. 10).

In one embodiment, one bit in the EHT variant Common Info field of Trigger frame 1105 may be used to indicate that it requests the recipient STA (MLD) of the Trigger frame to show the BQR of another link which is not the link where the trigger frame is transmitted. For example, one option is to use B22 (or any bit in B56 to B63) in the EHT variant Common Info field as a “Different Link Request”, which indicates the request information of another link, e.g., another link is mmW link or dependent link, which is not the link over which the trigger frame is transmitted. In other embodiments, an option is to add the one bit in the Trigger Dependent Common Info subfield of EHT variant Common Info field when the Trigger Type is BQRP Trigger frame. As an example, when this bit is set to =1, it indicates to request the BQR information of a secondary link, e.g. mmW link or dependent link; when this bit is set to=0, it indicates to request the BQR information of the primary link over which the Trigger frame 1105 is transmitted. Alternatively, N (where N>1) bits can be used for “Link Indication.” For example, N (e.g., N=4) bits can be carried in the Trigger Dependent Common Info subfield or any N (e.g., N=4) bits in B22, B56-B63 of EHT variant Common Info field. The N bits follow the definition of the Link ID Subfield in the Link ID Info subfield of the Common Info field of the Basic Multi-Link element.

FIG. 11 shows a method 1100 for a WTRU communicating in a wireless network using enhanced BQRP Trigger frame. If the AP-MLD sends to a non-AP MLD an enhanced BQRP Trigger frame 1105 which requests the BQR of the non-AP MLD on another/secondary link which is different from the link over which the enhanced BQRP Trigger frame 1105 is transmitted (e.g., another link may be the mmW link or dependent link), the non-AP MLD will send back the enhanced data frame 1110 that carries an enhanced HT Control field which indicates the BQR on the secondary/dependent link.

In another embodiment, the responding frame 1110 can be an enhanced control frame or management frame which carries the enhanced HT Control field. The link that is used for sending back the enhanced data/management/control frame 1110 carrying the enhanced HT control field may be the same link where the AP MLD transmits the trigger frame 1105.

Embodiments for cross-link signaling using Enhanced HLA Control are disclosed herein. In some embodiments, the Enhanced HLA Control subfield may contain the link adaptation related information (e.g., solicited or unsolicited MCS/Nss) of another link (e.g., mmW or dependent link) which is different from the link where the frame carrying the Enhanced HLA Control subfield is transmitted.

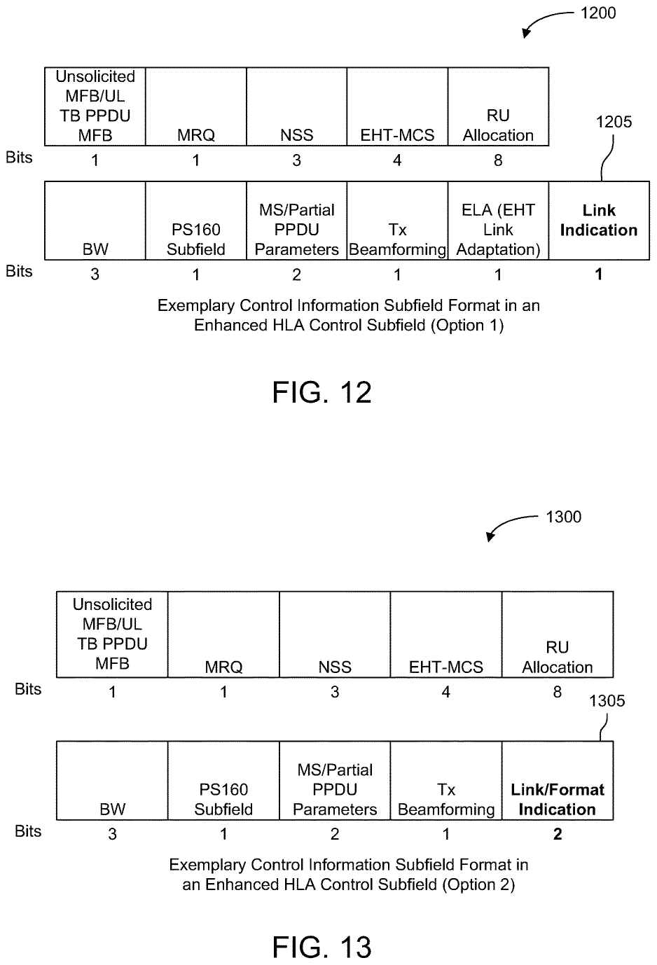

FIGS. 12 and 13 depict exemplary Control Information subfield formats in respective enhanced HLA Control subfields 1200 and 1300, according to different embodiments. FIG. 12 shows that 1-bit is allocated to the Link Indication subfield 1205, which indicates if this HLA Control subfield represents the link quality information (e.g., MCS, Nss) for the link where the frame which carries this HLA Control subfield is transmitted or not. For example, if Link Indication subfield=1, it represents the information carried in HLA Control subfield is for another link (e.g., mmW Link, dependent link) which is different from the link where the frame carrying this HLA Control subfield. Alternatively, if Link Indication subfield=0, it represents the information carried in HLA Control subfield is for the link associated with the frame carrying this HLA Control subfield, i.e., the primary link.

FIG. 13 shows an embodiment where 2-bits are allocated to Link/Format Indication subfield 1305. Example encoding of these two bits is shown in Table 6 below and exemplary encoding of Link/Format Indication subfield 1305 in the Control Information subfield in an enhanced HLA Control shown in FIG. 13.

TABLE 6
Encoding of Link/Format Indication subfield in the
Control Information subfield in an enhanced HLA

| Bits | |
|---|---|
| representation | Encoding |
| 00 | HLA for the link carrying the HT control |
| 01 | EHT LA for the link carrying the HT control |
| 10 | LA for another link (e.g., mmW link or dependent |
| | link) which is different from the link carrying |
| | the HT Control |
| 11 | LA for another AP (e.g., shared AP or slave AP, |
| | coordinating AP) or AP-MLD (e.g., shared AP-MLD |
| | or slave AP-MLD, coordinating AP-MLD) |

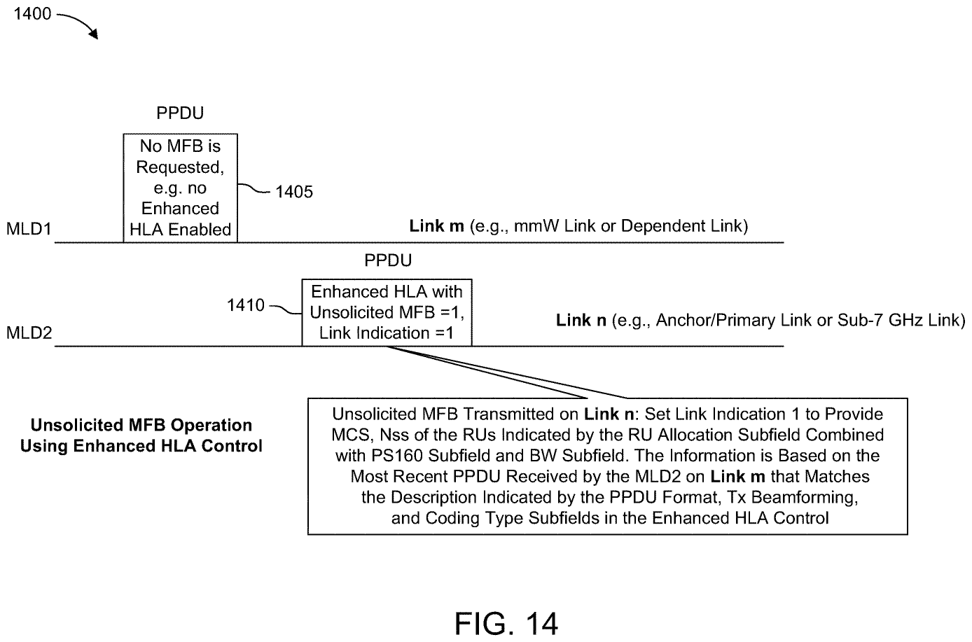

Referring to FIG. 14, a method 1400 for wireless communication with Enhanced HLA Control to enable an enhanced unsolicited MCS feedback (MFB) operation. In example method 1400, MLD1 transmits frame 1405 on Link m without requesting MFB. MLD2 sends the enhanced unsolicited MFB 1410 (with Unsolicited MFB subfield set to =1 and Link Indication subfield set to =1). The information carried in the enhanced HLA A-control subfield may contain MCS, Nss of the RUs indicated by the RU allocation subfield combined with PS160 and BW subfields. The information is based on the most recent PPDU received by the MLD2 on Link m that matches the description indicated by the PPDU format, Tx Beamforming, and Coding Type subfields in the enhanced HLA Control. Link n may not be same as Link m.

For example, if these two bits are set to 00, it means it is an HLA Control subfield; if these two bits are set to =01, it means it is an ELA (EHT Link Adaptation) Control subfield; if these two bits are set to =10, it means it is an ELA Control subfield or enhanced ELA subfield which carries the related link information (e.g., MCS/Nss) for another concurrent link (e.g., mmW link or dependent link) which is different from the link where the frame carries this enhance HLA Control subfield. If these two bits are set to =11, it means it is an ELA subfield or enhanced ELA subfield which carries the related link information (e.g., MCS/Nss) for another AP (e.g., sharing AP or slave AP or coordinating AP) or AP-MLD (e.g., sharing AP-MLD or slave AP-MLD or coordinating AP-MLD).

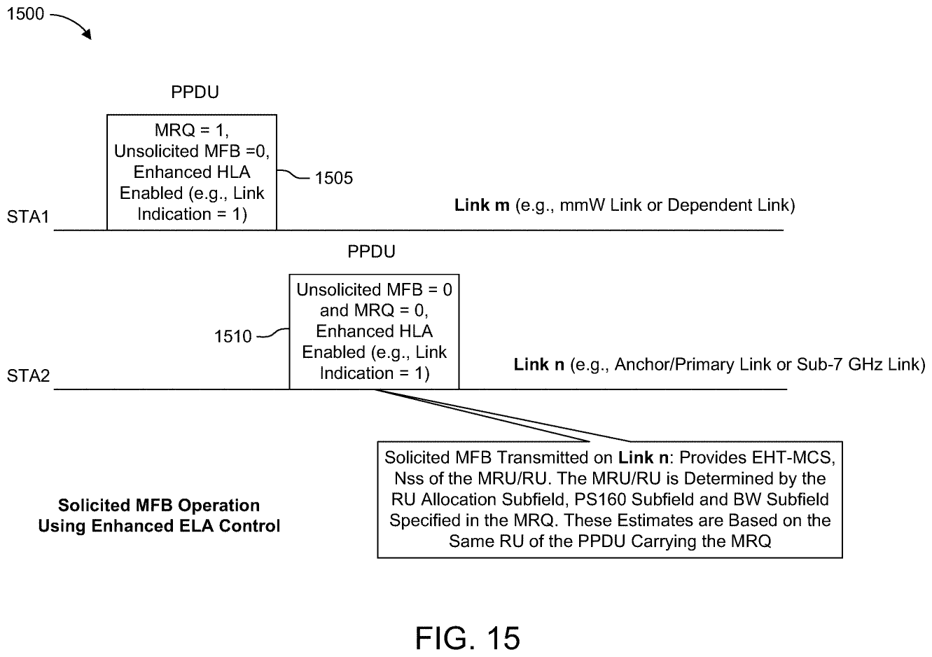

Referring to FIG. 15, a method 1500 for wireless communication using cross-link signaling with Enhanced HLA Control can be used to enable an enhanced solicited MFB operation. FIG. 14 depicts the exemplary operation of a solicited MFB. In this example, MLD1 transmits a frame 1505 carrying an enhanced HLA subfield with MRQ=1 and Link Indication=1 on Link m. MLD2 send the enhanced solicited MFB 1510 (with MRQ=0, Unsolicited MFB subfield set to =0 and Link Indication subfield set to =1) on Link n. The information carried in the responding frame 1510 (sent from MLD2 on Link n) with the enhanced HLA A-control subfield may contain MCS, Nss of the RUs indicated by the RU allocation subfield combined with PS160 and BW subfields specified in the frame carrying the enhanced HLA subfield with MRQ=1. Link n may not be same as Link m. Alternatively, in the solicited MFB, a STA may include the enhanced HLA on one link but request the estimation of the PPDU transmitted on another link. The recipient STA of this PPDU may transmit the estimated MCS/Nss on the link where the requested MFB is transmitted.

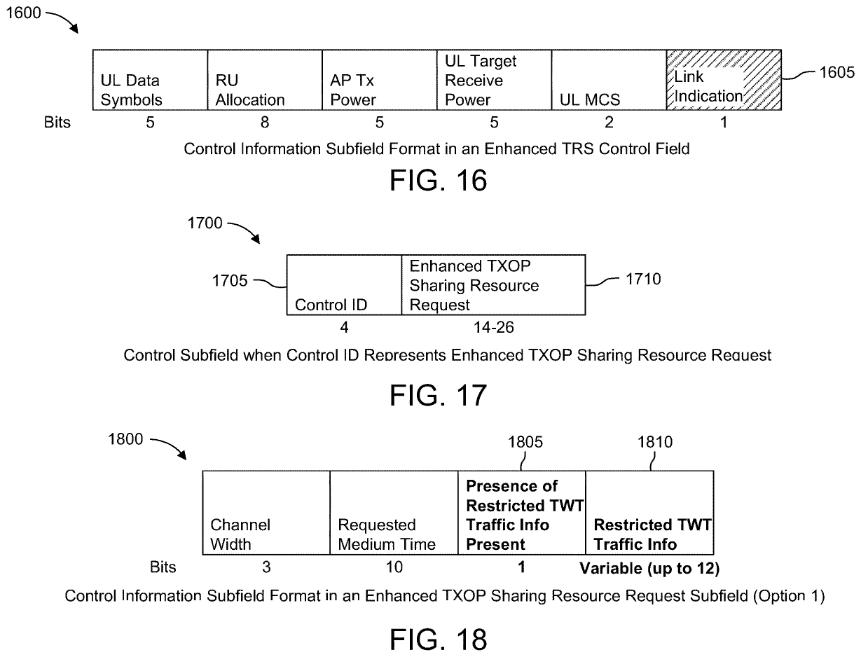

Enhanced TRS Control embodiments are also described in reference to FIG. 16. In one embodiment, an enhanced triggered response scheduling (TRS) Control may be used to solicit the TB PPDU which is transmitted on another link which is different from the link that carries the enhanced TRS Control. FIG. 16 depicts the exemplary Control Information subfield format in an enhanced TRS Control field 1600. In this example, Link Indication field 1605 is to request the recipient MLD to send the TB PPDU on the same link as the frame carrying the enhanced TRS Control field or not. For example, if the Link Indication subfield 1605 is set to 0, it indicates the requested TB PPDU is sent on the same link as the link that carries the enhanced TRS Control field; if the Link Indication subfield 1605 is set 1, it indicates the requested TB PPDU is sent another link (e.g., mmW link or dependent link) which is different from the link that carries the enhanced TRS Control field 1600.

In other embodiments, referring to FIG. 17, cross-link signaling may utilize an Enhanced TXOP Sharing Resource Request configuration 1700. In one embodiment, the enhanced TXOP sharing resource request may indicate its request for resource allocation for the P2P (PC5) traffic. Specifically, this embodiment may indicate if the STA which sends the frame carrying the enhanced TXOP Sharing request contains low latency traffic or not. For example, an Enhanced TXOP Sharing Resource Request is included in the A-Control subfield as a new type of Control information, examples of which is shown in Table 7 below. FIG. 17 depicts the Control subfield when Control ID 1705 represents an Enhanced TXOP Sharing Resource Request 1710.

TABLE 7
Control ID Subfield Values with a New
Control ID (Enhanced TXOP Sharing)

| | | Length of the |
|---|---|---|
| | | Control Information |
| Control ID value | Meaning | subfield (bits) |
| Any value between | Enhanced TXOP Sharing | 14 or more |
| 10 to 14 | Resource Request | (up to 26 bits) |

Referring to FIG. 18, embodiments with enhanced TXOP Sharing Resource Request subfield 1800 may contain additional information related to Restricted target wake time (TWT) or R-TWT traffic (i.e., latency sensitive traffic) for the peer STA, e.g., Presence of Restricted TWT 1805 and/or Restricted TWT Info 1810. For example, the Presence of Restricted TWT Traffic Info subfield 1805 is set to 1 if the Restricted TWT Traffic Info subfield 1810 is present; and set to 0 otherwise. If the STA has latency sensitive traffic for its peer STA, it will set the Presence of Restricted TWT Traffic Info subfield 1805 to 1.

FIG. 18 depicts an embodiment having one option of the exemplary Control Information subfield format in an Enhanced TXOP Sharing Resource Request subfield 1800 (Option 1). There may be multiple options to define the Restricted TWT Traffic Info subfield 1810.
Option 1a: The Restricted TWT Traffic Info subfield 1810 may contain a Delta Delay Bound subfield (not shown). The Delta Delay Bound subfield may contain an unsigned integer which represents the difference from the actual delay bound and the delay bound threshold which may be defined by the system. The actual delay bound specifies the maximum amount of time, in microseconds, allowed to transport an MSDU or A-MSDU belonging to the P2P traffic flow, measured between the time marking the arrival of the MDU, or the first MDU of the MSDUs constituting an A-MSDU, at the local MAC sublayer from the local MAC SAP and the time of completion of the successful transmission or retransmission of the MSDU or A-MSDU to the destination. This Delta Delay Bound only has a value when it is smaller than a threshold. For example, if the actual delay bound equals to or larger than the threshold value, the Delay Bound subfield is set to 0; otherwise, the Delay Bound subfield is set to the difference in integer between the actual delay bound and the threshold value. The threshold value may or not be included in the Restricted TWT Traffic Info subfield 1810.
Option 1b: The Restricted TWT Traffic Info subfield 1810 may contain a Delay Bound subfield (not shown). The Delay Bound subfield may contain a value which specifies the maximum amount of time, in microseconds, allowed to transport an MSDU or A-MSDU belonging to the P2P traffic flow, measured between the time marking the arrival of the MDU, or the first MDU of the MSDUs constituting an A-MSDU, at the local MAC sublayer from the local MAC SAP and the time of completion of the successful transmission or retransmission of the MSDU or A-MSDU to the destination. The value set in the Delay Bound subfield may be a quantized value.

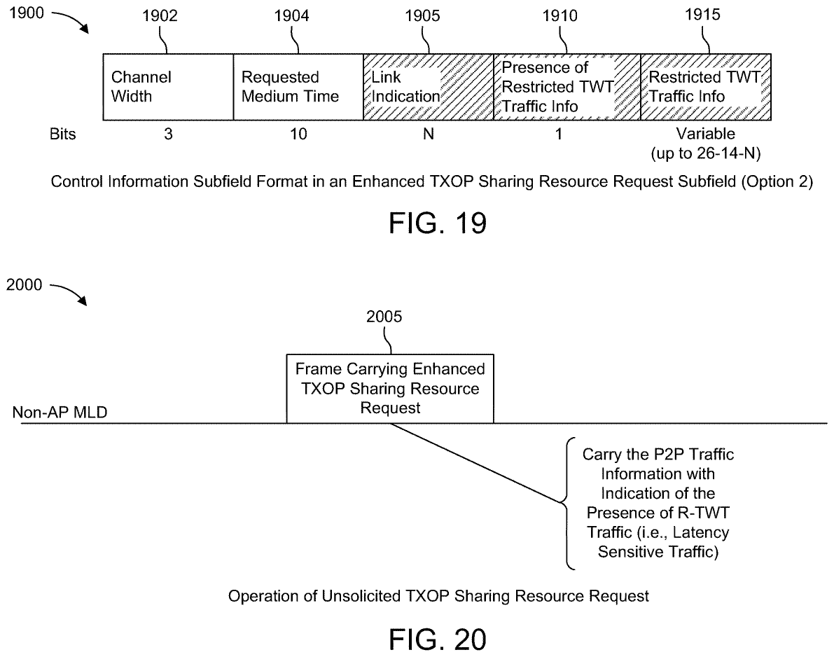

Referring to FIG. 19, an alternative embodiment with another option of Control Information subfield format in an Enhanced TXOP Sharing Resource Request subfield 1900 is shown. In the example of FIG. 19, there is a Link Indication subfield 1905, which indicates the link for which the Channel Width (i.e., the maximum bandwidth of the P2P Link) and the Request Medium Time are requested for the P2P transmission. The Link Indication subfield 1905 contains N bit, where N>=1. For example, in case of N=1, if Link Indication subfield 1905 is set=1, it may indicate the maximum channel width (shown in the Channel Width subfield 1902) and request medium time (shown in Requested Medium Time subfield 1904) are applied to a secondary link (e.g., mmW link or dependent link) which is not the link where the frame carrying the Enhanced TXOP sharing is transmitted; otherwise it may indicate the maximum channel width (shown in the Channel Width subfield 1902) and the requested medium time (shown in the Requested Medium Time subfield 1904) are applied to the link where the frame carrying the Enhanced TXOP sharing is transmitted. If Link Indication subfield 1905 indicates the link ID, then the maximum channel width (shown in the Channel Width subfield 1902) and request medium time (shown in the Requested Medium Time subfield 1904) are applied to the link whose link ID is indicated in the Link Indication subfield 1905.

This TXOP Sharing Resource Request may also be set by the AP or AP-MLD. If the frame carrying the TXOP Sharing Resource Request is sent from AP, the AP may use one or more than one bit in TXOP Sharing Resource Request to indicate to another MLD that the AP/AP-MLD request the recipient of this frame to indicate if there is P2P traffic in any link. If the sender of the frame carrying the TXOP Sharing Resource Request is an AP/AP-MLD, then the Presence of Restricted TWT Traffic Info subfield 1910 and Restricted TWT Traffic Info subfield 1915 are reserved.

Embodiments for operation of Enhanced TXOP Sharing Resource Request will now be described. In various embodiments, the enhanced TXOP Sharing may be unsolicited/solicited. In other words, the non-AP MLD can send the P2P traffic information via Enhanced TXOP A-control subfield which is triggered by the AP MLD. Alternatively, it can send the P2P traffic information via Enhanced TXOP A-control subfield without requesting from the AP-MLD.

Referring to FIG. 20, a method 2000 for wireless communication with unsolicited TXOP Sharing Resource Request is shown. A non-AP MLD may transmit an unsolicited frame 2005 which carries an enhanced TXOP Sharing Resource Request in A-Control field to an AP MLD. The Enhanced TXOP Sharing Resource Request may indicate to the AP that there is a P2P traffic which requires the resource allocation and that latency traffic is present, i.e., the presence of R-TWT traffic. FIG. 18 gives an exemplary operation of a Control Information subfield 1800 for an unsolicited TXOP Sharing Resource Request. In this example, the R-TWT traffic (latency sensitive traffic) is present in P2P traffic, e.g., the Presence of Restricted TWT Traffic Info subfield 1805 is set to =1.

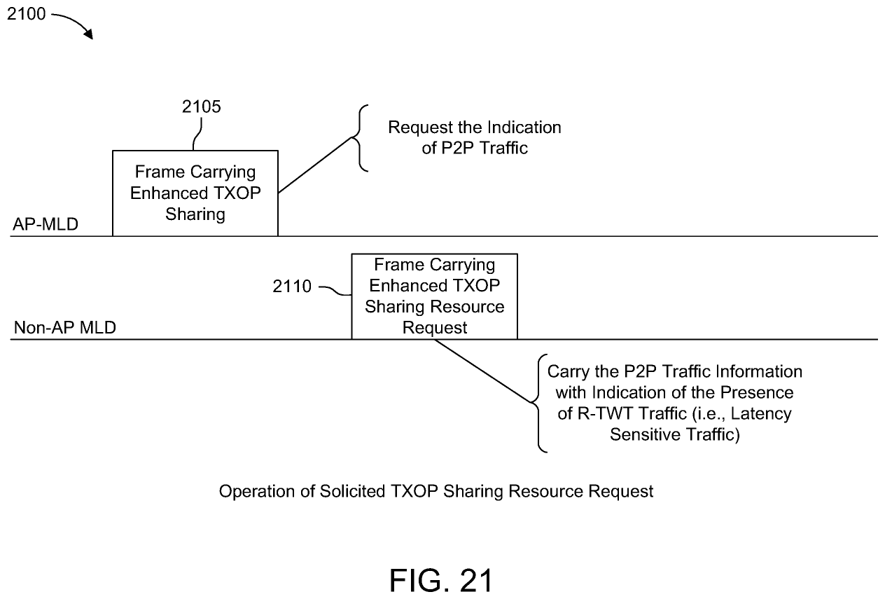

As shown in FIG. 21, a method 2100 for wireless communication for solicited TXOP Sharing Resource Request using enhanced cross-link signaling is shown. A non-AP MLD may transmit a solicited frame 2110 which carries enhanced TXOP Sharing Resource Request in A-Control field to an AP/AP MLD after it receives the TXOP Sharing Resource Request 2105 from the AP/AP MLD. FIG. 18 gives an exemplary configuration of a solicited TXOP Sharing Resource Request. In this example, the non-AP MLD indicates that it requests resource allocation for the P2P traffic and the R-TWT traffic (latency sensitive traffic) is present in P2P traffic, e.g., the Presence of Restricted TWT Traffic Info subfield 1805 is set to =1. The P2P traffic may be on a different link from the one where the frame exchange is performed.

In the various embodiments discussed previously, it is important for an MLD to inform neighboring devices of its capabilities to perform cross-link signaling. In one embodiment, the report or request via enhanced A-Control subfield for another link (e.g., mmW link, dependent link) which is different from the link which carries the report or the request information, e.g. the enhanced A-Control subfield may include BQR, HLA, etc., may be included in one more subfields of the MAC Capabilities Information field. In other words, the capability to support the Enhanced BQR Control, enhanced HLA Control or any Control ID included in the A-Control subfield may be indicated as a whole support or separately indicated. For example, if a STA indicates it supports the enhanced A-Control subfield (e.g., the corresponding subfield in the MAC Capabilities Information field is set to =1), it means it supports the enhanced A-Control subfield including all Control ID; if a STA indicates it does not support the enhanced A-Control subfield (e.g., the corresponding subfield in the MAC Capabilities Information field is set to =0), it means it doesn't support the enhanced the enhanced A-Control subfield including all Control IDs.

Alternatively, the MAC Capabilities Information field may contain multiple subfields to separately indicate if a STA supports a particular enhanced Control ID or not. For example, if a STA indicates it supports the enhanced BQR Control subfield, e.g., the corresponding subfield in the MAC Capabilities Information field is set to =1, the AP can request the STA to send the enhanced BQR Control subfield, or the STA can send the unsolicited information carried in the enhanced BQR Control subfield to another STA (if both STAs support the enhanced BQR Control subfield). If the STA does not indicate it supports the enhanced BQR Control subfield, e.g., the corresponding subfield in the MAC Capabilities Information field is set to =0, then the AP cannot request the non-AP STA to send the enhanced BQR Control subfield, or the STA cannot send the unsolicited information carried in the enhanced BQR Control subfield to another STA (if any one of the receiver STA or transmitter STA does not support the enhanced BQR subfield). The similar rule is applied whether support for the enhanced HLA Control subfield or enhanced TXOP Sharing subfield, etc. may be communicated.

Although the features and elements of the present embodiments are described in preferred embodiments and particular combinations, each feature or element can be used alone without the other features and elements of the preferred embodiments or in various combinations with or without other features and elements of the present embodiments. Furthermore, while embodiments described herein consider 802.11 specific protocols, it is understood that the embodiments are not so limited and are applicable to other wireless systems where suitable advantages may be obtained. Additionally, even within the 802.11-specific embodiments, other existing or future signaling and control fields may be utilized for cross-link signaling without departing from the scope of embodiments described herein.

Although SIFS is used to indicate various inter frame spacing in the examples of the designs and procedures, all other inter frame spacing such as RIFS, AIFS, DIFS or other agreed time interval could be applied in similar solutions. Further, although sub-7 GHz link/band has been used to refer to a link in MLO system where the control/management frames may be transmitted for mmW link/band, there is no limitation regarding frequency spectrum, and, for example, any link of a multiple link system having a more stable and efficient capability for control information may be applicable to the embodiments discussed herein.

Additionally, although reference has been made to a first field/subfield/element/sub-element in a second field/subfield/element/sub-element/frame, the first field/subfield/element/sub-element may be carried in other fields/subfields/elements/sub-elements/frames to indicate the same information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a multi-link station (ML STA), the method comprising:
transmitting, to a multi-link access point (ML AP) on a first wireless link, capability indication that the ML STA supports exchanging over the first wireless link, control information for a second wireless link different than the first wireless link;
receiving a request frame from the ML AP on the first wireless link, the request frame indicating the request frame contains a request corresponding to the second wireless link; and
transmitting a response frame to the ML AP on the first wireless link, the response frame indicating the response frame contains a response corresponding to the second wireless link.

2. The method of claim 1, wherein the request or the response includes link adaptation control information for the second wireless link.

3. The method of claim 2, wherein the first wireless link is in a sub-7 GHz frequency band and the second wireless link is in a millimeter wave (mmW) frequency band.

4. The method of claim 2, wherein the link adaptation control information is included in an A-Control subfield of a high efficiency (HE) variant high throughput (HT) control field.

5. The method of claim 1, wherein the request frame comprises a trigger frame.

6. The method of claim 2, wherein the request includes the link adaptation control information for the second wireless link and wherein the response confirms adaptation of the second wireless link.

7. The method of claim 2, further comprising:
transmitting or receiving a data frame over the second wireless link based on the link adaptation control information received over the first wireless link.

8. The method of claim 1 wherein the request corresponding to the second wireless link includes an enhanced bandwidth query report (BQR) subfield.

9. The method of claim 1 wherein the request corresponding to the second wireless link includes high efficiency link adaptation (HLA) control subfield.

10. The method of claim 1 wherein the request corresponding to the second wireless link includes an enhanced triggered response scheduling (TRS) control field.

11. The method of claim 1 wherein the request corresponding to the second wireless link includes an enhanced transmission opportunity (TXOP) sharing resource request.

12. A multi-link station (ML STA) comprising:
a transceiver; and
a processor in communication with the transceiver, wherein the processor and transceiver configured to,
transmit, to a multi-link access point (ML AP) on a first wireless link, capability indication that the ML STA supports exchanging over the first wireless link, control information for a second wireless link different than the first wireless link;
receive a request frame from the ML AP on the first wireless link, the request frame indicating the request frame contains a request corresponding to the second wireless link; and
transmit a response frame to the ML AP on the first wireless link, the response frame indicating the response frame contains a response corresponding to the second wireless link.

13. The ML STA of claim 12, wherein the request or the response includes link adaptation control information for the second wireless link.

14. The ML STA of claim 13, wherein the first wireless link is in a sub-7 GHz frequency band and wherein the second wireless link is in a millimeter wave (mmW) frequency band.

15. The ML STA of claim 13, wherein the link adaptation control information is included in an A-Control subfield of a high efficiency (HE) variant high throughput (HT) control field.

16. The ML STA of claim 12, wherein the request frame comprises a trigger frame.

17. The ML STA of claim 13, wherein the request includes the link adaptation control information and the response confirms adaptation of the second wireless link.

18. The ML STA of claim 17, wherein the processor and the transceiver are further configured to,
send or receive a data frame over the second wireless link based on the link adaptation control information received over the first wireless link.
